(19) United States
(12) Patent Application Publication
(10) Pub. No.: US 2018/0029742 A1
(43) Pub. Date: Feb. 1, 2018

(54) A LIQUID DISPENSING DEVICE

(71) Applicant: BOSIGN AB, Stockholm (SE)

(72) Inventors: Harald HYNELL, Vaxholm (SE); Ulf BYSTEDT, Stockholm (SE)

(21) Appl. No.: 15/549,767

(22) PCT Filed: Feb. 4, 2016
(86) PCT No.: PCT/SE2016/050084

§ 371 Date: Aug. 9, 2017

(30) Foreign Application Priority Data
Feb. 12, 2015 (SE) 1550155-4

(51) Int. Cl. B65D 1/32; B65D 47/06; B65D 35/44; B65D 35/02; B05B 11/04; B05B 15/00

(52) U.S. Cl. CPC B65D 1/323; B05B 11/048; B05B 15/005; B65D 35/44; B65D 35/02; B65D 47/06

(57) ABSTRACT

A manually operated demand delivery liquid pump dispensing device, includes: —a container (2) to be filled with a storage (20) of the liquid to be dispensed and with air inside the container, said container comprising a bottom part (6), a top part (5), and a side wall (7) between said bottom part and said top part, and a lid (3) which seals an opening (4) in the top part of the container, usable for filling the container, said lid being provided on the upper side thereof with a shallow basin (15), including, in the centre thereof, a concave dish-shaped cavity (21) and a discharge opening in the region of said dish-shaped cavity of the lid, and with a tube (22) for supplying liquid to said concave dish-shaped cavity from said storage of liquid which may be contained in the container. Said tube has an exterior top section (22a) extending upwards from the bottom of said concave dish-shaped cavity (21), and an interior section (22b) extending downwards from said top section into the storage of the liquid which may be contained in the container.

### TECHNICAL FIELD

The present invention relates to a manually operated demand delivery liquid pump dispensing device. Specifically, the invention aims at providing a dispensing device which is useful particularly in connection with manual dishing with a dish-brush at a wash hand stand.

### BACKGROUND OF THE INVENTION

Conventionally, in connection with manual dishing with a dish-brush, some liquid washing-up detergent is manually discharged from a plastic bottle into a dishpan or sink; however, sometimes too much, sometimes too little, but seldom a proper amount. It is also conventional to dispense, now and then, some liquid washing-up detergent directly on the dish-brush, but even that simple procedure involves difficulties as far as supplying a proper amount of detergent is concerned.

U.S. Pat. No. 2,752,069 discloses a container to be filled with a supply of a liquid to be dispensed and with air inside the container, said container comprising a bottom part, a top part including a lid which seals an opening usable for filling the container, and a side wall between said bottom part and said top part, the lid being provided with a shallow and concave dish-shaped portion and a discharge opening in the bottom of said dish-shaped portion of the lid, and with a conduit for supplying liquid to said concave dish-shaped portion from a storage of liquid which may be contained in the container. This prior art dispenser is designed to be used particularly in hospitals, doctor offices, or the like, where frequent and repeated use of a small quantity of alcohol or other surface medicament is necessary. It may also be used to dispend liquid cosmetics in beauty parlors and barber shops. Typically, a wad or ball of absorbent material, such as a wad of absorbent cotton, is placed in the dish-shaped portion of the lid, where the liquid is sucked up by the absorbent cotton wad. As an alternative, excess liquid is drained back into the container for future use

In principle a dispenser of the type which is disclosed in U.S. Pat. No. 2,752,069 also could be used for wetting a dish-brush with a liquid washing-up detergent. In that case, the dish-brush could be pressed against the top part of the dispenser, more specifically against the top part of the dispenser in the region of the concave dish-shaped portion, such that the lid is deflected and an amount of liquid detergent is pressed up, filling the concave little basin and wetting the brush. However, a dish-brush in use is not clean. Therefore, every time as the dish-brush is wetted by means of this prior art type of dispenser, some impurities, such as fragmentized food leavings, soot and grime is deposited in the concave dish-shaped portion and drains back into the container together with excess liquid that remains in the concave dish-shaped portion. As such contaminated liquid repeatedly is drained back into the container, the impurities will successively collect there and not only make the liquid in the container disgusting but finally useless.

### BRIEF DISCLOSURE OF THE INVENTION

It is the purpose of the present invention to address the above mentioned problem in order to provide an improved liquid dispensing device which is particularly useful in connection with manual dish-washing by means of a dish-brush. This and other objectives can be achieved therein that the above mentioned conduit, for supplying liquid to said concave dish-shaped portion from a storage of liquid which may be contained in the container, has an exterior top section extending upwards from the bottom of said concave dish-shaped portion, and an interior section extending downwards from said top section into the liquid which may be contained in the container. Other characteristic features, objects and advantages of the invention will be apparent from the following description and from the appending patent claims.

### BRIEF DESCRIPTION OF THE DRAWINGS

In the following description of the invention, reference will be made to the accompanying drawings, in which

FIG. 1 is a perspective view of an embodiment of the assembled liquid dispensing device according to the invention,

FIG. 2 is a perspective view of the dispensing device disassembled, part A showing a lid and part B showing a container included in the dispensing device

FIG. 3 is a side view of the assembled device, a part of a bottom part partly in section,

FIG. 4 shows a lid in cross section along its symmetry line, and

FIGS. 5, A and B, illustrate how the container, which is included in the device of the invention can, be compressed in the direction of a central axis (8) of the device.

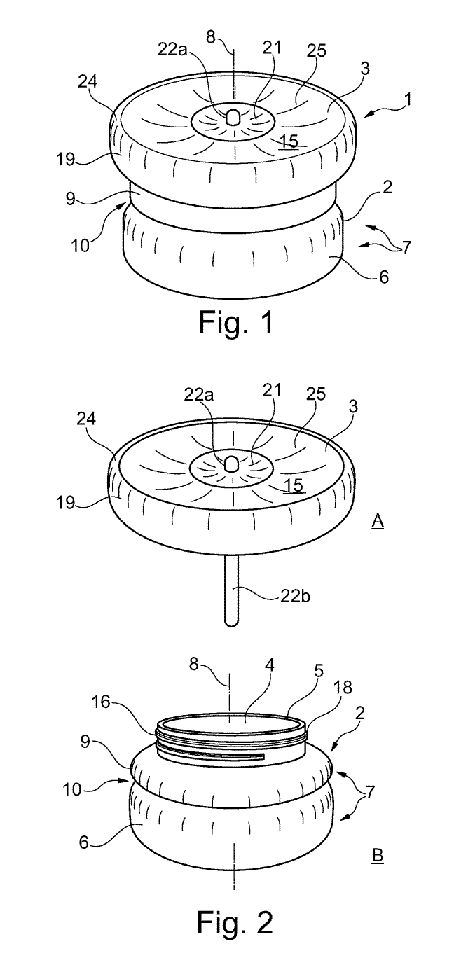

### DETAILED DESCRIPTION OF THE INVENTION

In the drawings, a manually operated demand delivery liquid pump dispensing device is generally designated 1. It consists of a container 2 and a lid 3 which seals a container opening 4 in the end of a top part in the form of a short neck 5. On said top part/neck 5, external threads 6 are provided, adapted to cooperate with internal threads 16 in the lid 3, such that the lid 3 can be screwed on the container for tight sealing or easy refill of the container opening 4.

The container 2 is made of a thermoplastic polymer resin of the polyester family. Most conveniently, it is made of transparent polyethylene terephthalate, commonly abbreviated PET, which can be semi-rigid to rigid and is typically used in food and other liquid containers. The container 2 comprises said neck 5, which is a top part of the container, a bottom part 6, and a side wall 7, FIG. 5A, between said bottom part 6 and said top part or neck 5. Since the PET material is semi-rigid to rigid, it has a correspondingly low elasticity. Therefore, because it shall be possible to use the device of the invention as a pump, the side wall 7 is designed such that it can be compressed in the axial direction of the container 2 without at the same time widening it, when the top part/neck 5 is pressed towards the bottom part 6. The volume of the bottom part 6, in the disclosed embodiment of the invention, represents more than 50% (about 70%) of the total volume of the container 2.

As shown in FIG. 5A, the outer and inner surfaces of the side wall 7 are geometrically defined as surfaces generated by serpentine shaped lines rotated about the central axis 8 of container 2. More specifically, the container wall 7 has an annular bulge 9 below the top part/neck 5 and a pronounced waist 10 between bulge 9 and bottom part 6. Upper and lower, annular surfaces and wall sections of the bulge 9 are designated 12 and 13, respectively. The bottom part 2 is much larger than the bulge 9 as well in its radial as in its axial directions and therefor also in terms of its volume. As a matter of fact, the volume of the bottom part represents more than 50% of the total volume of the container 2. The bottom part 6 is also wider than bulge 9. This also means that the annular, upper wall section 14 of the bottom part 6 is wider than the upper and lower wall sections 12 and 13 of the bulge 9. As is also apparent from FIG. 5 A, the extension of the container wall 11 in the region of the waist 10 is very short and represents not more than 10% of the entire length of the container's 2 side wall 7 in the axial extension, thereof.

Now, with reference to FIG. 5A, when the top part 5 is pressed towards the bottom part 6, all the said annular wall sections 12, 13 and 14 will be deflected to some degree, i.e. be bent upwards or downward as the case may be. All these deflections cause a compression of the container's side wall 7 to some degree, and this is particularly true as far as the lower wall section 13 is concerned, because of its larger extension in its radial direction. Therefore, because of the deflections of the annular wall sections 12, 13 and 14 of the container, when closed by the lid 3, the device of the invention may be used as a pump for the purpose that will be explained in following. First, however, also the lid 3, its design, its use and its mode of operation shall be explained.

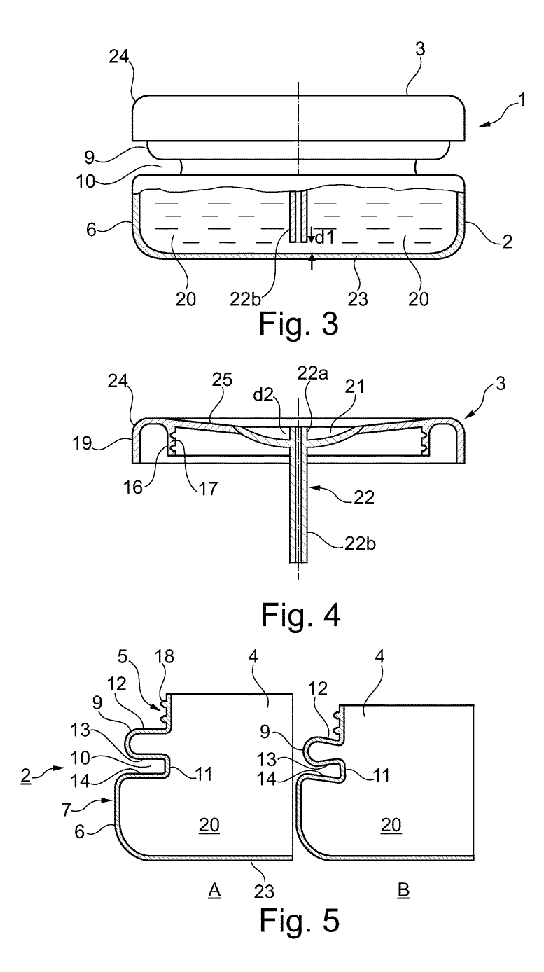

The lid 3 consists of a rigid type of polymeric material. A convenient material is for example polyethylene but also others may be employed as well. Like any lid, its purpose by definition is to be a closure. In the present case it shall seal the opening 4 which is used for filling the container 2 with a liquid detergent when the lid 2 has been removed. That, however, is not the only objective of the lid. Another objective of the lid is to form a basin 15 for the distribution of the liquid washing detergent to a dish-brush. Inter alia for that purpose, the lid is wider than would be necessary just for its closure function. The lid is also made stiffer than necessary for its closure function, in order that it shall not be deflected or in other way deformed when it is pressed against the container, when the container shall work as a pump for pumping up liquid detergent 20, FIG. 3, from the container to a basin 15. The lid 3 therefor has two downwards directed flanges; one inner flange 16 with inner threads 17 matching the outer threads 18 on the container neck 5, and an outer flange 19 which promote the rigidity and non-flexibility of the lid 3. According to the embodiment, the lid, which extends to the said outer flange 19 via a rounded top portion 24 of lid 3 is at least as wide as the bottom part 6 of the container 2 or wider, and the outer flange 19 has a length in its axial direction that is longer than that inner flange 16 which is provided with said inner threads 17.

In its center, the lid 2 has a concave portion, forming a shallow cavity 21, in the following referred to as cup 21, in the centre of the basin 15. The width (diameter) of cup 21 is about ⅓ of the entire width of the basin 15. A tube 22, forming a conduit for the transportation of the liquid detergent from a store 20 of liquid detergent in the container 2 to the shallow cavity 21 on top of the lid 3, has two sections; an exterior top section 22a extending upwards from the bottom of said concave dish-shaped cavity 21, and an interior section 22b extending downwards from said top section into the store 20 of liquid detergent which may be contained in the container. According to the disclosed embodiment, FIG. 3, the interior section 22b ends at a short distance d1 from the bottom 23 of the container 2, when the container is closed by the lid but not subjected to pressure. Further, according to the invention, the upper, exterior section 22a ends at a distance d2 from the bottom of the cup 21 in the centre thereof, said distance d2 being equal with the depth of the cup 21. Around the cup 21, from the rounded top portion 24 of the lid 3 down to the periphery of the cup 21, the basin 15 includes an annular portion, in the following referred to as brim 25, which surrounds the cup 21 and which geometrically may be defined as a truncated cone. The bottom surface of basin 20 in the region of the brim 25 slopes at an inclination angle of about 12°. For reasons which shall be explained in the following, the outer diameter d1 of the brim 25 is at least twice as large as the diameter d2 of the cup 21. Most conveniently it is about three times as large. This, however, also has an impact on the total height of the device 1. In view of its considerable width, the overall height of the device should be smaller than its width, in order not only that the total size of the device should not be inconveniently large, but also because the device shall be stable and allow a dish-brush to be pressed against the lid without risk that the device will turn over.

The device of the invention, as described above, functions in the following way. The store 20 of liquid detergent is supplied to the container 2 through the opened opening 4, whereupon the container is closed by screwing the lid 3 tightly to the top part/neck 5 of the container. The section 22b of the tube is submerged into the store 20 of liquid detergent to the said distance d1 from container bottom 23. Now, the lid 3 and the top part 5 of the container 2 is pressed down by a dish-brush or by hand towards the bottom part 6. This causes the annular wall sections 12 and 13 of the annular bulge 9, and in particular the annular, wider top wall 14 of the bottom part 6 of the container, to be deflected, FIG. 5 B. These deflections cause the side wall 7 of the container 2 to be compressed, and hence the volume of the container to be reduced. This in turn causes an amount of liquid detergent to be pressed—pumped—up from the store 20 of liquid detergent in the container 2 all the way through the conduit in the tube 22 up to the very end and be emptied from the top of the top section 22a of the tube into the cup 21.

Because the exterior top section 22a of the tube 22 extends a distance above the bottom of the cup 21, corresponding approximately to the depth of the cavity 21, the said top section 22a functions as a back valve, as long as the cup 21 is not overloaded with any liquid, which it is not normally. In order prevent or reduce the risk of overcharging the cup 21 with liquid detergent, the distance d1 between the lower end of the tube 22 and the container bottom 23 is fairly short, suitably of the same length as the length of the exterior top section 22a of the tube. Therefore, even if the lid 2 and the top part 5 of the container 2 are pressed maximally downwards, only a small amount of liquid detergent is charged into the cup 21, not exceeding the limit defined by the upper end of the exterior top section 22a. As a matter of fact, just a small amount of liquid detergent is sufficient for most dishing operations by means of a dish-brush, since the liquid detergent can be spread out by the disc-brush in the basin 15, where it will be efficiently brought into contact with the dish-brush, before it is applied to the object to be cleaned by the dish-brush which has been properly wetted with liquid detergent. In order that it shall be possible to move the dish-brush around in the basin 15, allowing the dish-brush to be well wetted by liquid detergent which has been supplied in the central cup 21 but at the same time avoid spattering the liquid detergent as well as food leavings and soiled dish-water around, the basin 15 should have a sufficient but not exaggeratedly large width. A width of between 8 and 12 mm is appropriate.

One would think that the basin 20 gradually would be soiled with food leavings, such as lard, grease or others. However, that does not occur normally. But would it occur, it would be easy to remove them as a final dishing operation. In connection to this, it should be mentioned that it would very well be possible even to flush the basin 15 with hot water, should that be necessary, without running the risk that any harmful amount of water, soiled or not, would flow down into the container through the tube 22, because the exterior top section 22a even in that case would work as a preventive valve.

1-16. (canceled)

17. A manually operated demand delivery liquid pump dispensing device, which includes:
a container to be filled with a storage of the liquid to be dispensed and with air inside the container, said container comprising a bottom part, a top par, and a side wall between said bottom part and said top part, and
a lid which seals an opening in the top part of the container, usable for filling the container, said lid being provided on the upper side thereof with a shallow basin, including, in the center thereof, a concave dish-shaped cavity and a discharge opening in the region of said dish-shaped cavity of the lid, and with a tube for supplying liquid to said concave dish-shaped cavity from said storage of liquid which can be contained in the container, wherein said tube has an exterior top section extending upwards from the bottom of said concave dish-shaped cavity, and an interior section extending downwards from said top section into the storage of the liquid which may be contained in the container.

18. The device according to claim 17, wherein the exterior top section of the tube has a length corresponding at least approximately with the depth of dish-shaped cavity.

19. The device according to claim 17, wherein the exterior top section of the tube has a length which equals the depth of the dish-shaped cavity.

20. The device according to claim 19, wherein the interior section of the tube ends at a distance from the bottom of the container in the center thereof, which distance corresponds at least approximately with the length of the exterior top section of the tube.

21. The device according to claim 17, wherein the container can be compressed in the direction of said central axis of the device.

22. The device according to claim 17, wherein the lid is made of a rigid material and cannot be compressed in the direction of a central axis of the device.

23. The device according to claim 22, wherein the container can be compressed due to the container wall being corrugated as viewed in cross section in a vertical plane along the said central axis.

24. The device according to claim 23, wherein the corrugated container wall includes annular wall sections, which in the non-compressed state of the container are parallel in planes which are perpendicular to said central axis.

24. The device according to claim 23, wherein said annular wall sections are not perpendicular to said central axis, but deflected, in the compressed state of the container.

25. A manually operated demand delivery liquid pump dispensing device, which includes:
a container to be filled with a storage of the liquid to be dispensed and with air inside the container, said container comprising a bottom part, a top part, and a side wall between said bottom part and said top part, and
a lid which seals an opening in the top part of the container, usable for filling the container, said lid being provided on the upper side thereof with a shallow and concave dish-shaped cavity and a discharge opening in the region of said dish-shaped cavity of the lid, and with a tube for supplying liquid to said concave dish-shaped cavity from said storage of liquid which may be contained in the container, wherein the container can be compressed in the direction of said central axis of the device, and the lid is made of a rigid material and cannot be compressed in the direction of a central axis of the device.

26. The device according to claim 25, wherein the container can be compressed due to the container wall being corrugated as viewed in cross section in a vertical plane along the said central axis.

27. The device according to claim 26, wherein the corrugated container wall includes annular wall sections, which in the non-compressed state of the container are parallel in planes which are perpendicular to said central axis.

28. The device according to claim 27, wherein said annular wall sections are not perpendicular to said central axis, but deflected, in the compressed state of the container.

29. The device according to claim 28, wherein the container includes a bottom part with a bottom and an annular wall section, which is one of said annular wall sections, and an annular bulge with an upper wall section and a lower wall section, said upper and lower wall sections being two of said annular wall sections.

30. The device according to claim 29, wherein its width is larger than its height, and the volume of said bottom part represents more than 50% of the total volume of the container.

31. The device according to claim 28, wherein at least one of the annular wall sections has a width amounting to at least 10% of the maximal width i.e. of the maximal diameter of the container.
